(19) United States
(12) Patent Application Publication
(10) Pub. No.: US 2013/0026327 A1
(43) Pub. Date: Jan. 31, 2013

(54) Configurable Modular Portable System for Enabling Selectively Adjustable Spatial Positioning and Dynamic Stabilization of an Apparatus

(71) Applicant: Etienne Sauret, New York, NY (US)

(72) Inventor: Etienne Sauret, New York, NY (US)

(73) Assignee: MYT WORKS, INC., New York, NY (US)

(21) Appl. No.: 13/561,721

(22) Filed: Jul. 30, 2012

Related U.S. Application Data
(60) Provisional application No. 61/513,311, filed on Jul. 30, 2011.

(51) Int. Cl. F16M 11/24

(52) U.S. Cl. 248/420

(57) ABSTRACT

The present invention is directed to a portable configurable modular spatial positioning and dynamic stabilization that enables mounting of at least one apparatus (e.g., camera, etc.) in accordance with at least one plural controllable mounting profile. The system of the present invention—the novel “Quadripod”—has four+ indepently moving legs, that can be adjusted up to 270 degrees (or more) both below and above the Quadripod plate. The. Quadripod knee joints . also allow by simply lifting them off their base to control the horizontal rotational angle through a dowel pin inside the new joint mechanism that can be inserted in the carrousel of matching holes on the upper part of the knee joint. Features also include the ability to underslung one plate below another by letting the rods slide through the plate. A major feature is also the ability to use standard commonly available speedrail pipes.

### FIELD OF THE INVENTION

The present invention relates generally to systems and devices for mounting devices such as cameras, lights, etc. in a controllable and movable, such as dollies, etc., and more particularly to portable configurable modular spatial positioning and dynamic stabilization system that enables mounting of at least one apparatus (e.g., camera, etc.) in accordance with at least one plural controllable mounting profile.

### DESCRIPTION OF THE DRAWINGS

In the drawings, wherein like reference characters denote corresponding or similar elements throughout the various figures:

FIG. 1A is an exemplary schematic top-down view diagram illustrating a first exemplary embodiment of the inventive portable configurable and selectively adjustable spatial positioning and dynamic stabilization (“SASPS”) system 10a usable for supporting, positioning, and stabilizing various types of equipment, such as camera/photography equipment, lights, etc. and having multiple connection receiving points throughout its body, comprising at least three anchor points 12 (four are shown by way of example only in various FIGS. 1A to 2D);

FIGS. 1B and 1C are exemplary isometric schematic side view diagrams illustrating first alternate exemplary embodiments of the inventive SASPS system 10a of FIG. 1A, shown as embodiments 10b and 10c, comprising preferably removable adjustable locking clamps 14 preferably rotably positioned in the anchor points 12, each releasably connected to a support element (e.g., a tube, rod or pipe) 16. As shown in FIG. 1C, each support element 16 can be oriented and positioned independently from one another by configuring and positioning of each adjustable locking clamp 14;

FIGS. 1D and 1E are exemplary isometric schematic side view diagrams illustrating second alternate exemplary embodiments of the inventive SASPS system 10a of FIG. 1A, shown as embodiments 10d and 10e, comprising preferably removable locking clamps preferably rotably positioned in the anchor points, each releasably connected to a support element (e.g., a tube, rod or pipe) as with SASPS system embodiments 10b and 10c, except that each support element is connected to an additional locking clamp at its other end that is each further movably and adjustably connected to a further secondary support element. As shown in FIG. 1E, each primary and additional support element can be oriented and positioned independently from one another by configuring and positioning of each set of primary and/or secondary adjustable locking clamps;

FIG. 2A is an exemplary schematic top-down view diagram illustrating a second exemplary embodiment of the inventive SASPS system 50a-1 usable for supporting, positioning, and stabilizing various types of equipment, such as camera/photography equipment, lights, etc. and having multiple connection receiving points throughout its support body 52, comprising at least three anchor points 54 (four are shown by way of example only), with a preferably removable adjustable locking clamp 56 positioned at each anchor point 54, each releasably connected to a corresponding support element 58, and an equipment mounting component 60 releasably positioned in a central region of the support body 52;

FIGS. 2A-2 and 2A-3 are exemplary isometric schematic side view diagrams illustrating the inventive SASPS system 50a-1 of FIG. 2A-1, shown in configured positions 50a-2 and 50a-3 which illustrate the capabilities of the SASPS system 50a-1 to (1) position the support body 52 at virtually any angle with respect to a reference “ground” surface, and/or to (2) position each adjustable locking clamps 56 along any desired position on its corresponding support element 58;

FIG. 2B-1 is an exemplary schematic isometric view diagram illustrating a third exemplary embodiment of the inventive SASPS system 50b-1 usable for supporting, positioning, and stabilizing various types of equipment, such as camera/photography equipment, lights, etc. and having multiple connection receiving points throughout its support body 52, comprising at least three anchor points 54 (four are shown by way of example only), with a preferably secured adjustable locking clamp 56 positioned at each anchor point 54, each releasably connected to a corresponding support element 58, and an equipment mounting component 60 releasably positioned in a central region of the support body 52;

FIG. 2B-2 is an exemplary isometric schematic side view diagram illustrating a first alternate exemplary embodiment of the inventive SASPS system 50b-1 of FIG. 2B-1 shown as embodiment 50b-2, comprising preferably secured adjustable locking clamps 64 positioned in the anchor points 62, each releasably connected to a support element (e.g., a tube, rod or pipe), where each support element can be inserted into a connection receiving point of the support body 52 and then positioned and stabilized by being releasably secured to a proximal adjustable locking clamp 64;

FIG. 2C is an exemplary schematic isometric view diagram illustrating a fourth exemplary embodiment of the inventive SASPS system 50d usable for supporting, positioning, and stabilizing various types of equipment, such as camera/photography equipment, lights, etc. and having multiple connection receiving points throughout its support body, comprising at least three anchor points (four are shown by way of example only), with a preferably secured adjustable locking clamp 68 positioned at each anchor point, such that each pair of clamps 68 can be positioned and oriented to releasably connect to a corresponding support element 66, such that the SASPS system 50d can be mounted below or above a pair (or more) of parallel support element 66 “rails”; and

FIGS. 3A-1 to 3C-2 show various views illustrating different operational positions of inventive and novel embodiments of various adjustable releasable locking clamps 100a to 200a (and components 102 to 202 thereof), that are preferably advantageously used in connection with various embodiments of

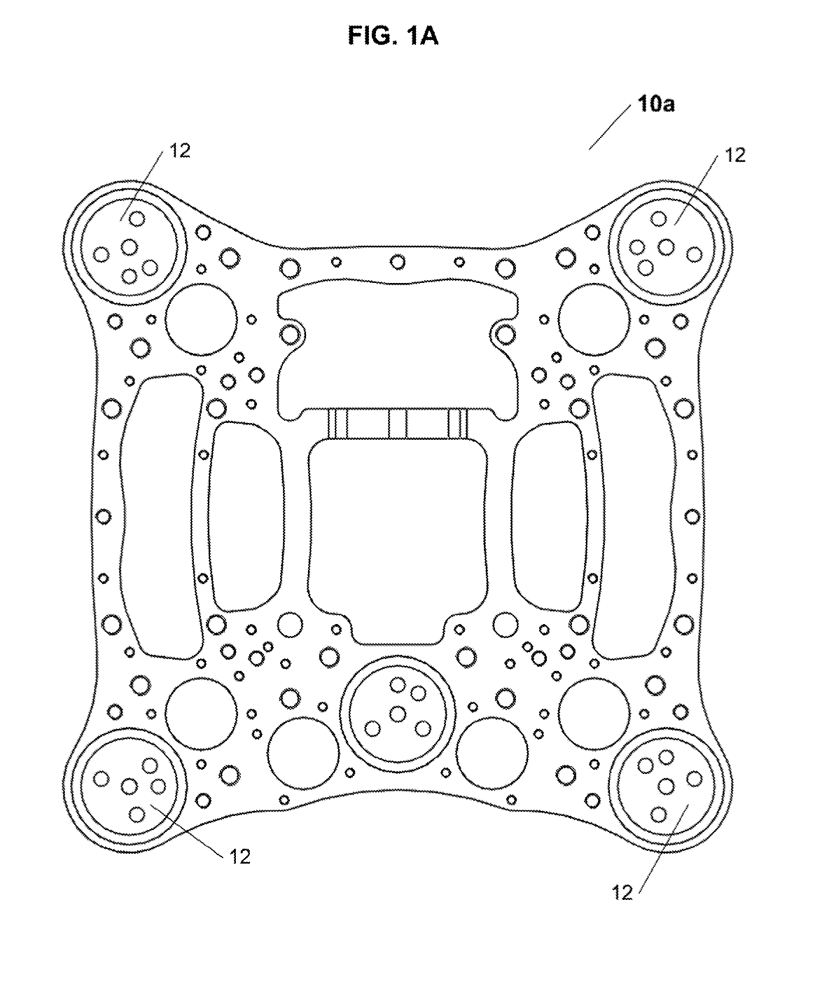

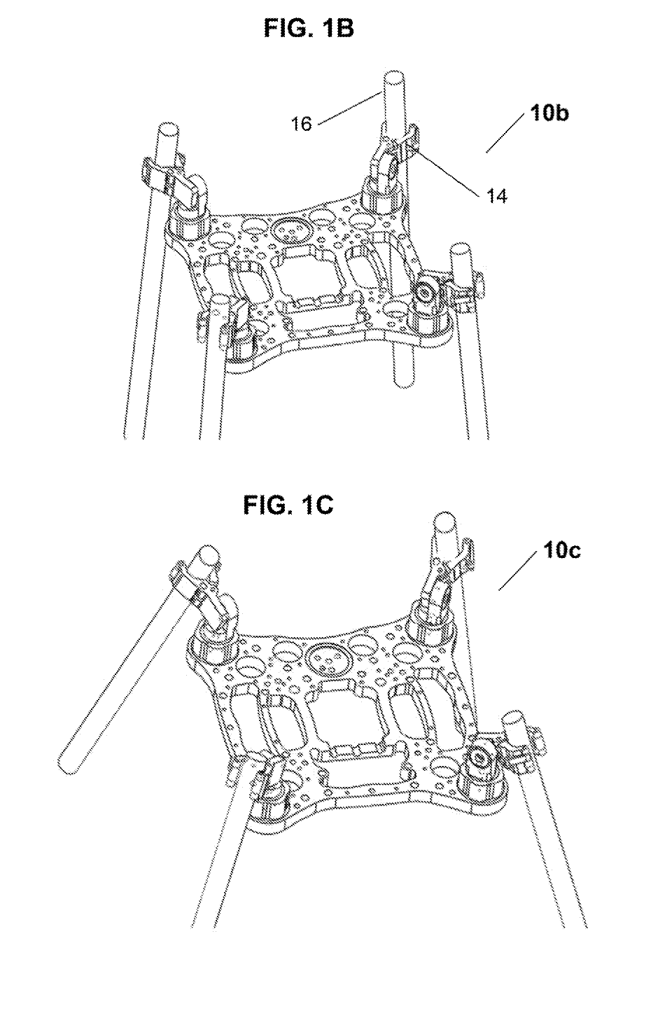

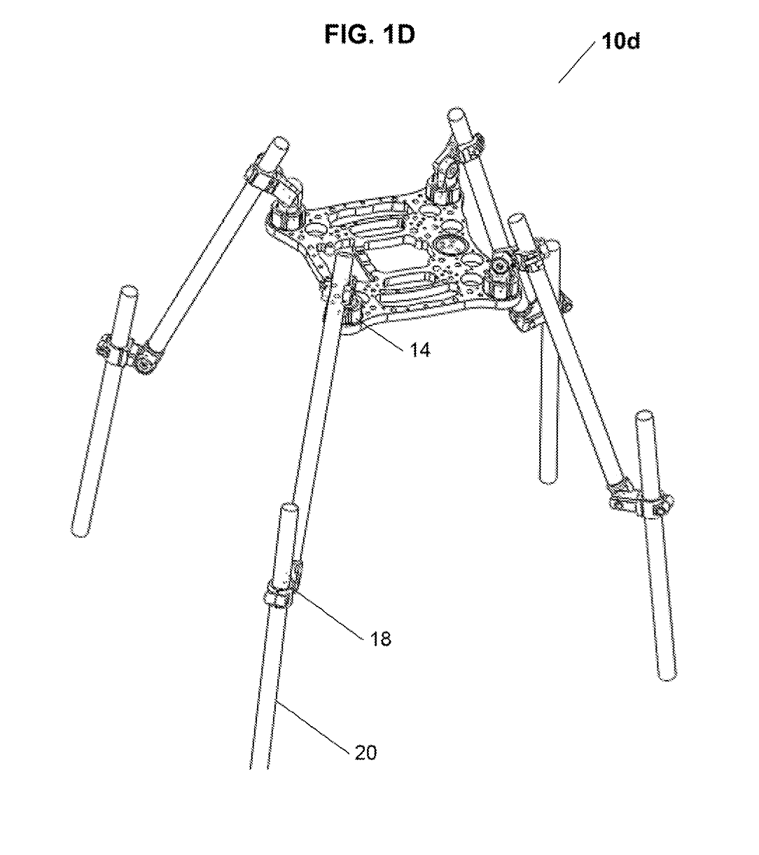

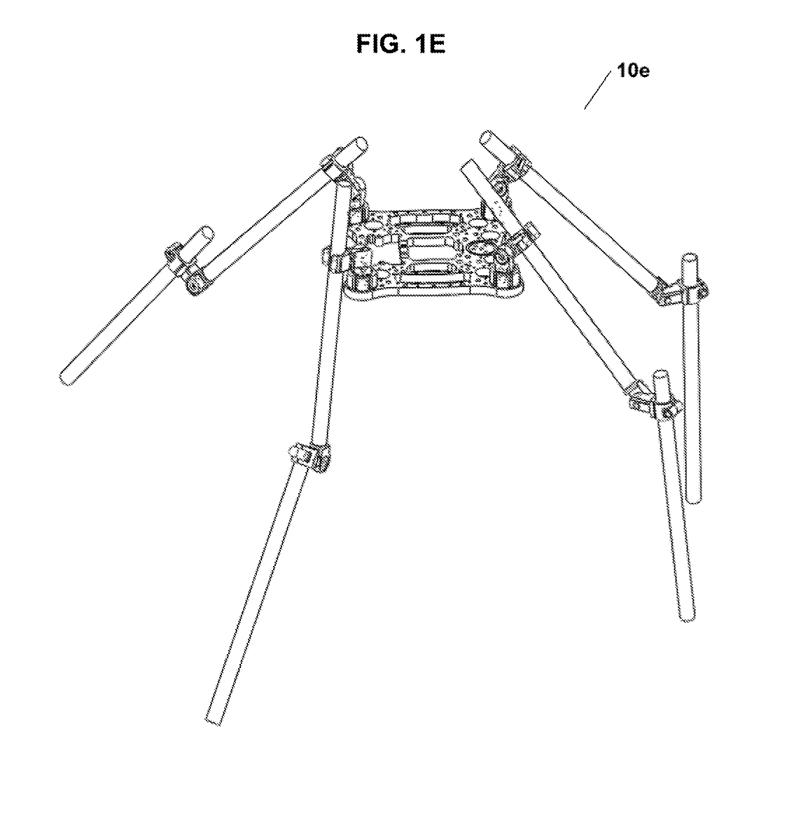

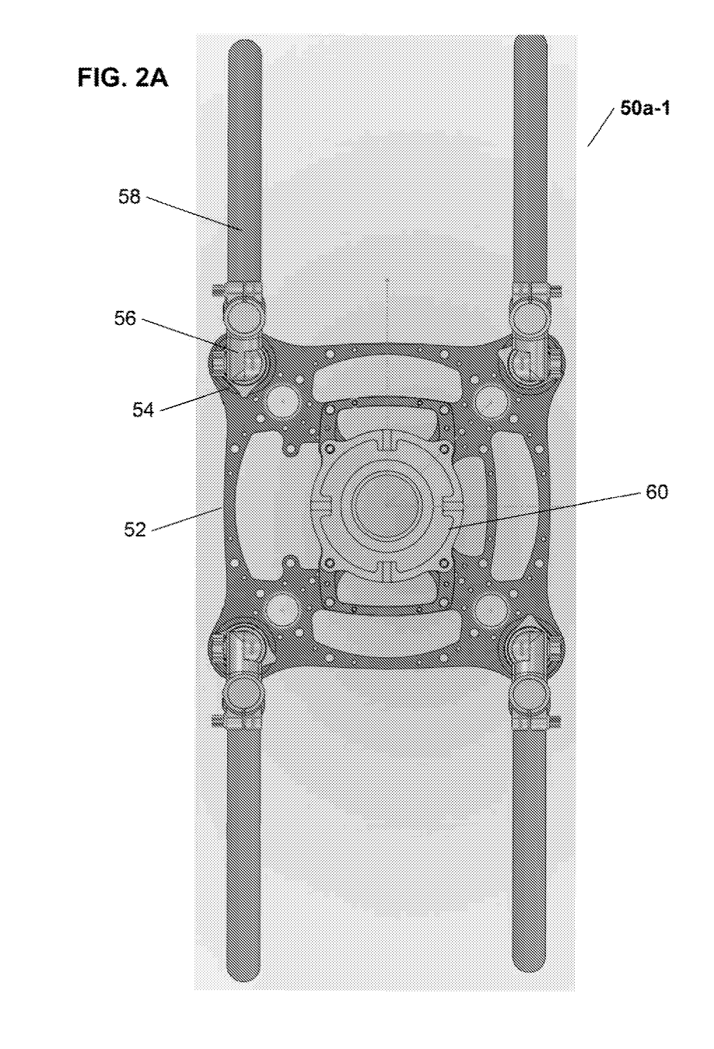

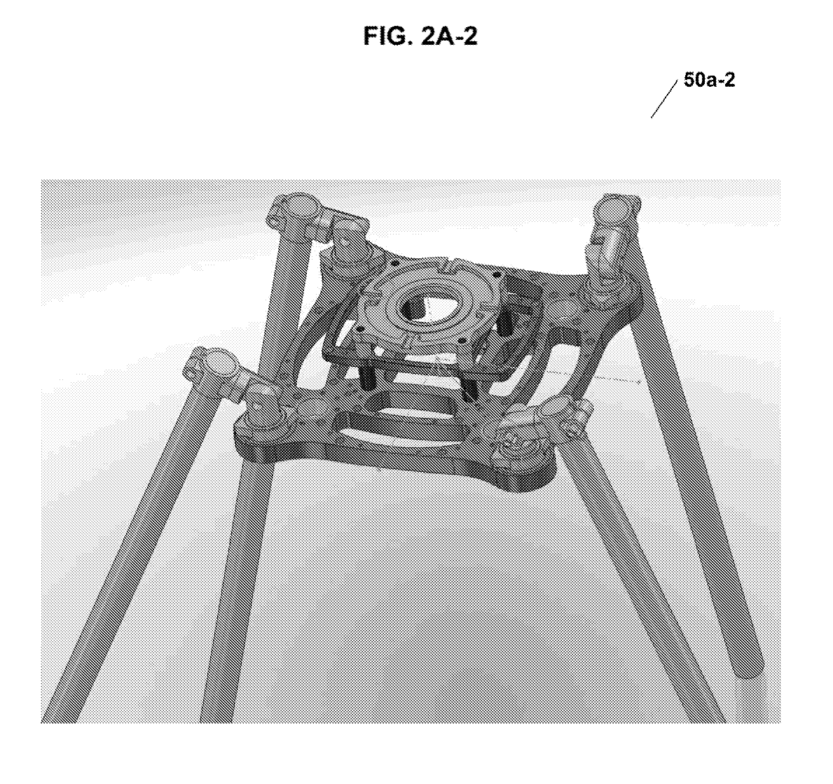

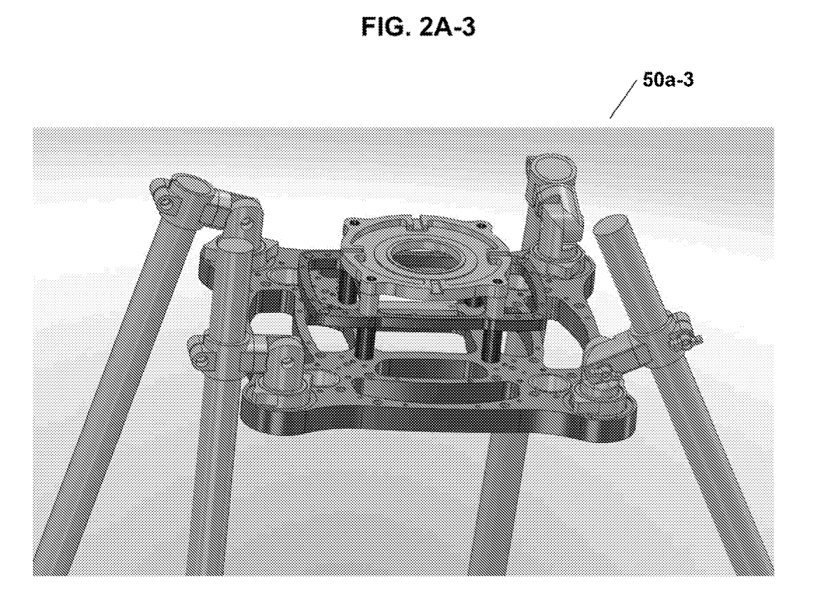

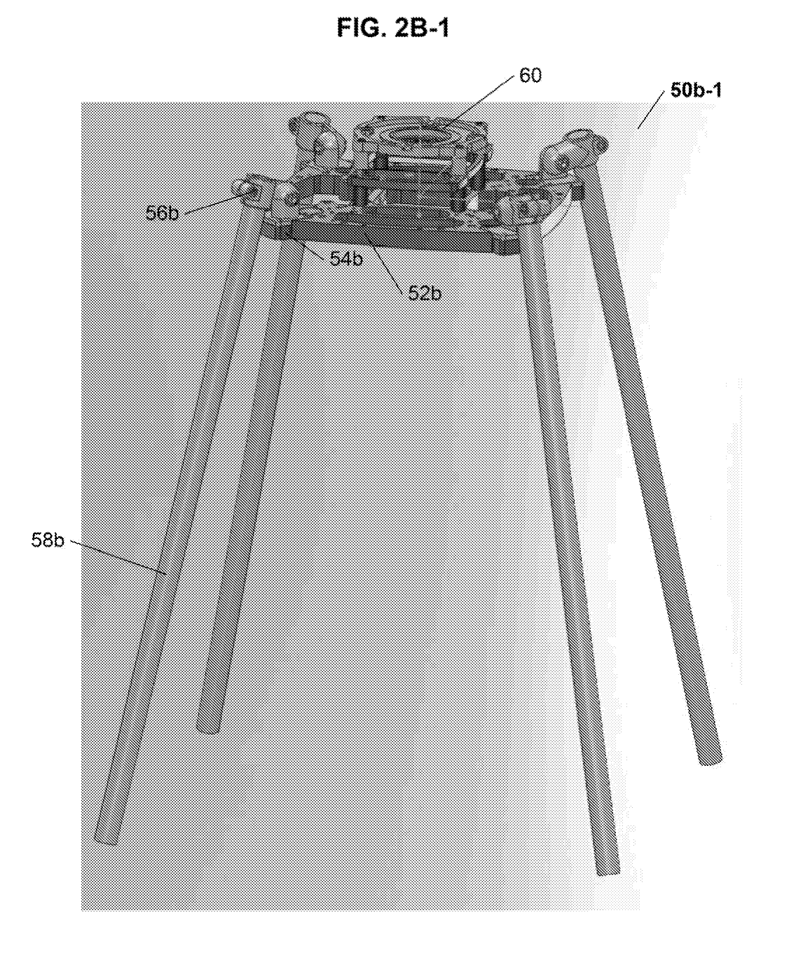

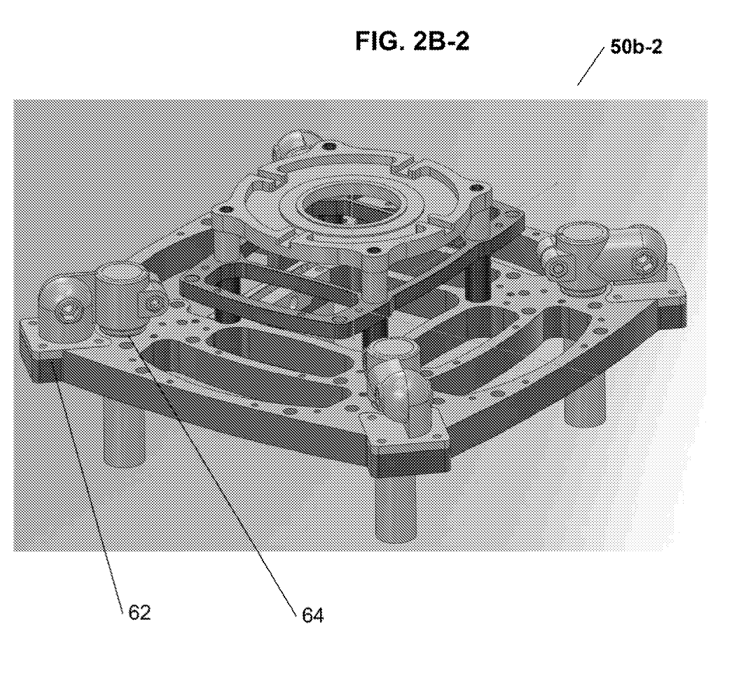

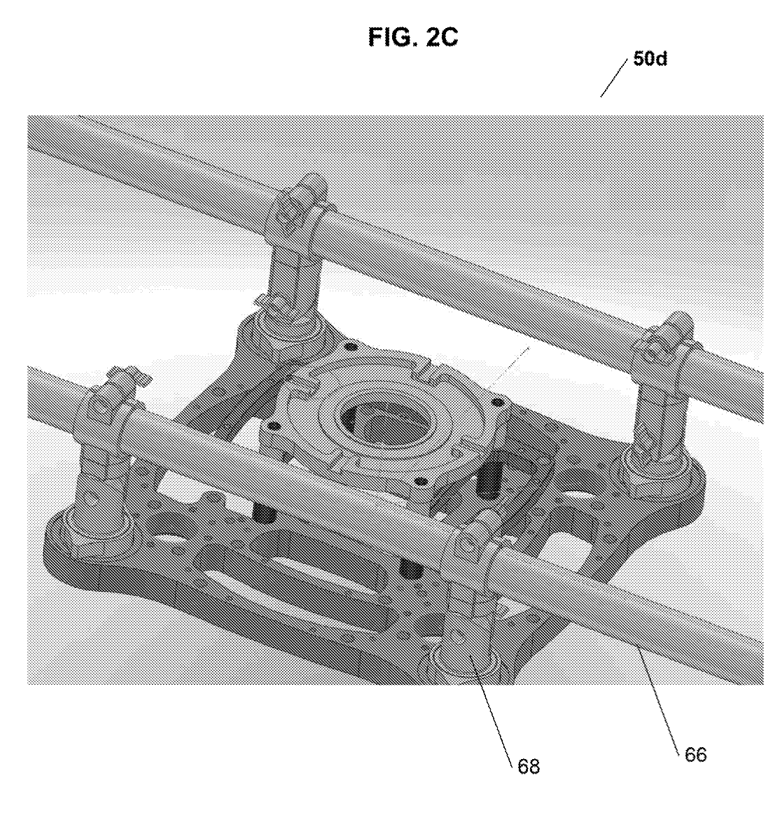

SASPS systems 10a to 50d of FIGS. 1A to 2C.

### BACKGROUND & DETAILED DESCRIPTION OF THE INVENTION

Tripods, for use in supporting and stabilizing various devices and equipment, have experienced only minimal improvements over the last century—the implementation of lighter materials with greater strength and smoother locking and control mechanisms having been the primary focus of evolution thereof. Otherwise, the design and engineering approaches behind tripod design and manufacturing have remained stubbornly simple. Accordingly, currently known tripods resist the addition of new functions and features that could add to the versatility of a tool universally used in the film and broadcast industry, not to mention by every basic consumer with a motion picture or video camera. This lack of design evolution has left people frustrated with the lack of options, reluctantly settling for the status quo.

In various embodiments thereof, the inventive portable configurable and selectively adjustable spatial positioning and dynamic stabilization (“SASPS”) system is usable for supporting, positioning, and stabilizing various types of equipment, such as camera/photography equipment, lights, etc. in a very wide range of spatial orientation, in any terrain, and with virtually unlimited flexibility in connectivity and equipment and anchoring mount options.

To fully understand the extend of advantages and benefits of various embodiments of the inventive SASPS system it would be useful to consider the drawbacks of, and challenges faced by, previously known tripod offerings:

Traditional tripod legs can be controlled up and down by either tubes joined together in pair and sliding parallel to one another or in telescopic tubing. Both solutions use a tightening system to hold them into place.
1) In most current designs, the legs are set at a 120-degree angle from one another. This is a nearly universal standard with a set range that is extremely limiting.
2) In telescoping systems, mostly used in still photography, a latch at the base can offer up to three angled positions in each leg: a slight angle for an upright position, one close to 45-degrees, and an obtuse one that allows the tripod to be close to the ground. However, there is still no capacity for adjustment beyond these fixed positions.
3) In traditional tripods, the angle is controlled by a spreader located in-between the legs at mid-level. This circumstance limits range and does not allow for low shots. It is possible to remove the spreaders in order to use the tripod on uneven terrain. This configuration, however, is very difficult to control as each leg moves freely since they are now mounted as free-standing rods. Lower heights can only be attained by using baby legs of hi-hats.
4) The tripod height is inherently limited to the height of the legs (which rarely exceeds 80″).
5) In order for the camera head to be mounted with stability and security, the base needs to be set up level.
6) The adjustment of one leg angle in relation to another, no matter how minimal, can only be accomplished by releasing the spreader and/or securing each leg independently.
7) Traditional tripods cannot be used upside down. Even with adaptors, they cannot be underslung.
8) Traditional tripods cannot function as a stand-alone hi-hat or with baby legs. Telescoping systems can do this, but only within the ranges determined by the length to which the legs are extended.
9) No system is able to seamlessly switch from a tripod to a Glider/Slider setup with a one-latch release system.
10) Traditional tripods do not allow for unlimited mounting options on the base itself.

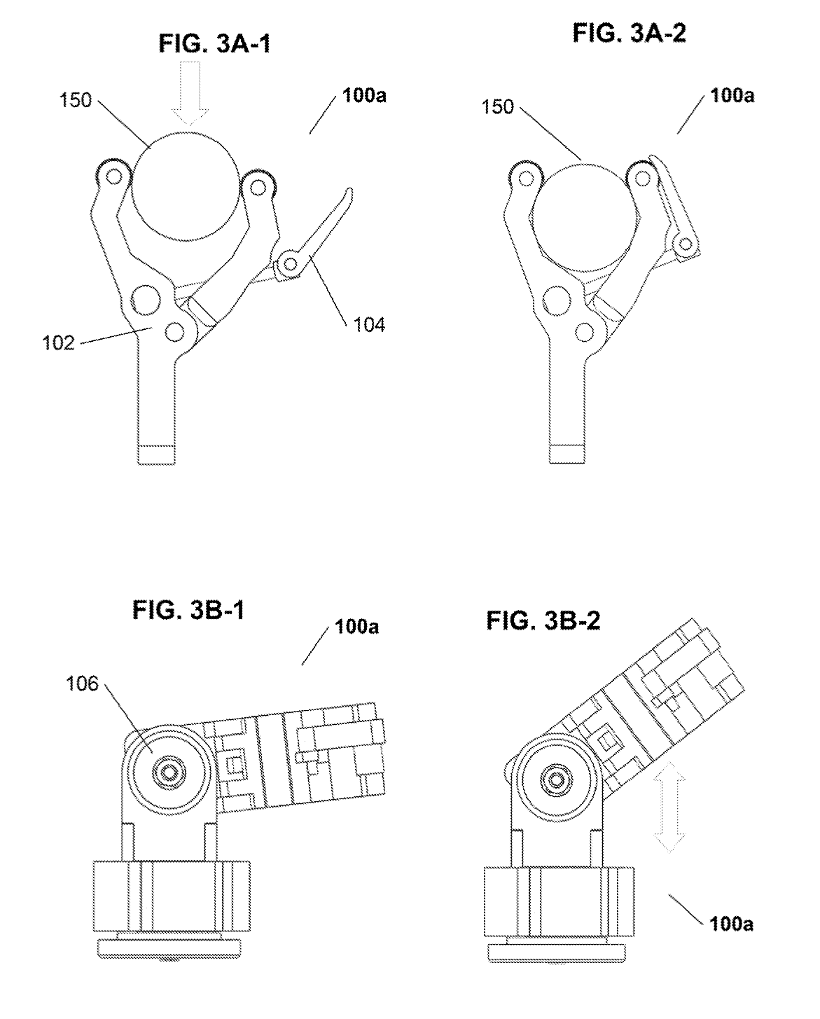

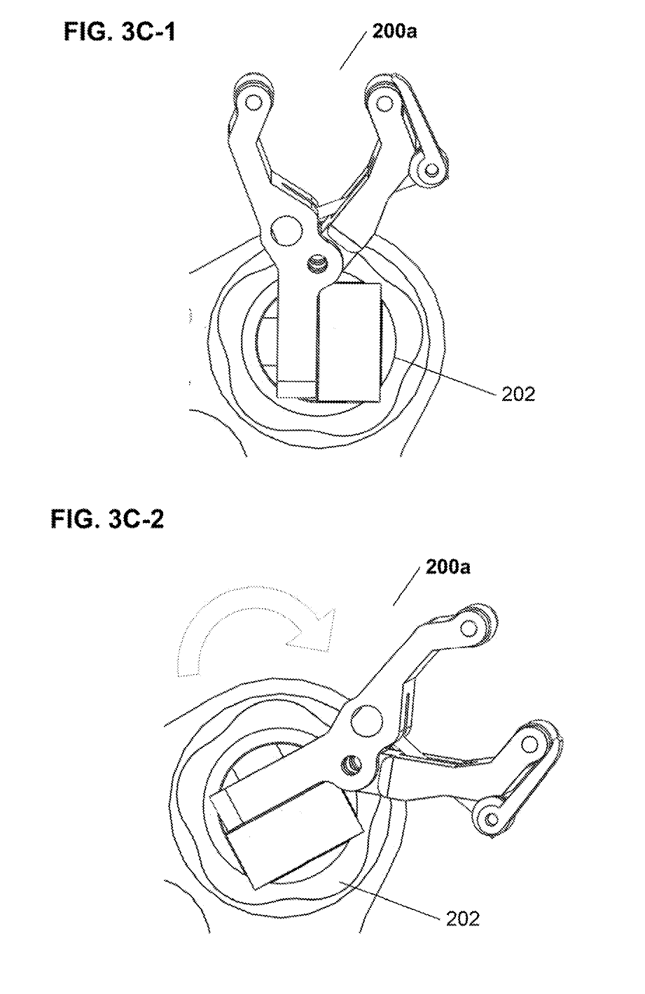

In stark contrast to the above-noted previously known tripod solutions, in various embodiments thereof, the inventive SASPS system overcomes all of the disadvantages of the previously known equipment mounting solutions for at least the following reasons:
1) The base can be used as a regular hi-hat base, optionally with a one-latch release for a compatible Hi-Hat component.
2) The revolutionary, modular design includes a support base with (preferably detachable) adjustable locking clamps (such as the inventive adjustable locking clamps shown in FIGS. 3A-1 to 3C-2). These locking clamps may comprise at least two rosette-type rings that lock into position when pressed against one another. Up to 60 or more positions may be available (depending on the number of teeth on the rosette) in three dimensions, made possible by the novel locking clamps that may allow for selected ranges of top, bottom, and/or rotational motion.
3) The SASPS system may comprise a knee joint that features eight to sixteen holes that can be positioned on a fixed dowel pin, which allows for lateral and horizontal positioning of the legs.
4) The combination of the rosette and the dowel pin with guide holes allows for unlimited combinations of angles for the legs (support elements), which are now capable of being positioned independently from one another.
5) Revolutionary new design that allows adjustment of leg height by simply releasing the latch on a corresponding novel locking clamp. The SASPS system is unique in allowing the legs to pass through the knee joints.
6) The SASPS system, in at least one embodiment thereof, allows for a secondary pass through hole that provides underslung capabilities in addition to square-legs set-up by allowing legs to go through the base in a vertical position.
7) The SASPS system allows for horizontal mounting of the legs, as well as for pass-through thereof.
8) The SASPS system can be utilized with either three, four, or more support elements (legs) as a matter of design choice (as a note, when utilizing the SASPS system with at least four legs, there is no weak tipping angle thereof).
9) The SASPS system is entirely modular, meaning that the leg height is adjustable to any length, be it long or short. Preferably, the support elements (legs) used in connection therewith are at least one of: stack-able, screw-able, lock-able, and ratchet-able.
10) The numerous connection receiving points in the support body of the SASPS system permit virtually unlimited mounting options for various equipment.

It should also be noted that the novel adjustable locking clamps shown in FIGS. 3A-1 to 3C-2, may be readily used in various other clamping applications, and not just with the different embodiments of the SASPS system. In summary, the novel adjustable locking clamps represent a fundamental new approach to the conventional way of securing a support element (such as, for example, a tubular type pipe) and locking it into place. In the traditional approach, the operator needs to open the clamp wide enough to insert the pipe and/or squeezing it into place past the jaws where the pipe remains loose until securing it. Then the operator must tighten the jaws to secure the pipe in place. In contrast, the novel adjustable locking clamps permit much easier and more convenient modes of operation: Two rollers set on dowel pins at the end of each jaw allows the pipe to be snapped into place between the jaws by rolling past the jaw's tips. The jaws are held into place via a spring that allows for constant tension. The pipe diameter can be preset with a dowel pin with 2 or more positions. On the inside walls of the jaws, high coefficient of friction material holds the pipe into place. The friction is small enough to still allow for adjustments. Once the operator is ready to lock, the latch on the clamp allows final securing. This approach offers an unprecedented way to pre-assemble. It is also much faster to attach pipes in any structure since they snap into place together and pipes don't need to be held while mounting others. The same goes for the reverse operation where the latch is released and the pipe is snapped out.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A portable configurable modular spatial positioning and dynamic stabilization comprising means for mounting of at least one apparatus (e.g., camera, etc.) in accordance with at least one plural controllable spatial positioning and mounting profile.
